(19) United States
(12) Patent Application Publication
(10) Pub. No.: US 2024/0351139 A1
(43) Pub. Date: Oct. 24, 2024

(54) LASER TOOL

(71) Applicant: Saudi Arabian Oil Company, Dhahran (SA)

(72) Inventor: Sameeh Issa Batarseh, Dhahran (SA)

(21) Appl. No.: 18/303,128

(22) Filed: Apr. 19, 2023

(51) Int. Cl. B23K 26/142; B23K 26/073; B23K 26/14; B23K 26/36; B23K 37/02

(52) U.S. Cl. CPC B23K 26/142; B23K 26/0732; B23K 26/1462; B23K 26/36; B23K 37/0241

(57) ABSTRACT

A laser tool includes a tool body disposed at least partially along a central longitudinal axis, and a head unit connected to the tool body with a rotational joint. The head unit rotates around the central longitudinal axis with the rotational joint, includes a laser head to direct a laser energy toward a target and along a second longitudinal axis of the head unit. A purging nozzle, fluidly connected to a fluid source, includes a nozzle outlet oriented at an angle relative to the second longitudinal axis of the head unit, and directs fluid at an angle into a pathway of the laser energy from the laser head to bias purged material out of the pathway of the laser energy. The rotational joint supports the head unit on the tool body, and moves the head unit in a radial direction relative to the central longitudinal axis.

### TECHNICAL FIELD

This disclosure relates to laser tools, such as surface or downhole laser tools.

### BACKGROUND

Laser tools can be used to output laser energy, such as a laser beam, within a wellbore or tubular. The laser energy can be used to extend or expand a wellbore, or ablate a component or material. The laser energy is directed at a target material, and heat from the laser energy breaks down the target material.

### SUMMARY

This disclosure describes laser tools.

In some aspects, a laser tool includes a tool body disposed at least partially along a central longitudinal axis, and a head unit connected to the tool body with a rotational joint. The head unit can rotate around the central longitudinal axis with the rotational joint, and the head unit includes a laser head to direct a laser energy toward a target and along a second longitudinal axis of the head unit, and a purging nozzle fluidly connected to a fluid source. The purging nozzle includes a nozzle outlet oriented at an angle relative to the second longitudinal axis of the head unit, and the purging nozzle directs fluid at an angle into a pathway of the laser energy from the laser head to bias purged material out of the pathway of the laser energy. The rotational joint supports the head unit on the tool body, and the rotational joint moves the head unit in a radial direction relative to the central longitudinal axis such that, in a first position of the rotational joint, the second longitudinal axis of the head unit is radially offset from the central longitudinal axis.

This, and other aspects, can include one or more of the following features. The tool body can include a housing at least partially enclosing the head unit and rotational joint. The laser tool can include a vacuum system having a vacuum housing configured to collect the purged material. The laser head can include comprises one or more optical lenses to control or direct the laser energy through the laser head. The laser head can include a laser opening having a rectangular shape or wedge shape, and the laser opening to direct the laser energy in a rectangular shape toward the target. The laser tool can include a laser source to provide the laser energy to the laser head. The purging nozzle can include a purging knife, and the nozzle outlet of the purging knife defines an outlet opening having a linear shape. The angle of the nozzle outlet can be directed at least partially toward the central longitudinal axis. The nozzle outlet and the laser head can be oriented at the same angle relative to the second longitudinal axis. The rotational joint can include a hinge joint to pivot about a hinge and move the head unit in the radial direction relative to the central longitudinal axis. In the first position of the rotational joint, the second longitudinal axis of the head unit can be parallel to and radially offset from the central longitudinal axis of the tool body. The head unit can include a camera at least partially directed at the target.

Certain aspects encompass a method including positioning a head unit of a laser tool in a first position relative to a central longitudinal axis of the laser tool, where the first position is radially offset from the central longitudinal axis. The laser tool includes a tool body disposed at least partially along the central longitudinal axis, the head unit is connected to the tool body with a rotational joint, the head unit includes a laser head and a purging nozzle fluidly connected to a fluid source, and the purging nozzle includes a nozzle outlet oriented at an angle relative to a second longitudinal axis of the head unit. The rotational joint supports the head unit on the tool body. The method further includes positioning the laser head of the tool body along the second longitudinal axis that is radially offset from the central longitudinal axis, directing, with the laser head, a laser energy toward a target along the second longitudinal axis, and directing, with the purging nozzle, a fluid from the fluid source at an angle into a pathway of the directed laser energy to bias purged material from the target out of the pathway of the directed laser energy.

These, and other aspects, can include one or more of the following features. The method can include rotating the head unit of the tool body about the central longitudinal axis. Positioning the head unit in the first position can include adjusting, with the rotational joint, a radial position of the head unit in a radial direction relative to the central longitudinal axis into the first position. The method can further include at least partially enclosing, with a housing, the head unit and rotational joint. The method can further include collecting, in a vacuum housing of a vacuum system of the laser tool, the purged material from the target. Directing the laser energy toward the target can include directing, with one or more optical lenses in the laser head, the laser energy through the laser head. Directing the laser energy with the one or more optical lenses can include shaping the directed laser energy into a rectangular shape toward the target. Directing the fluid with the purging nozzle can include directing the fluid through a nozzle outlet of a purging knife, where the nozzle outlet defines an outlet opening having a linear shape. Directing the fluid at the angle through the nozzle outlet of the purging knife can include directing the fluid out of the nozzle outlet at least partially toward the central longitudinal axis.

In certain aspects, a laser tool includes a tool body disposed at least partially along a central longitudinal axis, and a head unit connected to the tool body with a rotational joint and can rotate around the central longitudinal axis. The head unit includes a laser head to direct a laser energy toward a target along a second longitudinal axis of the head unit, and a purging nozzle fluidly connected to a fluid source and including a nozzle outlet. The purging nozzle directs fluid into a pathway of the laser energy from the laser head to bias purged material out of the pathway of the laser energy. The rotational joint supports the head unit on the tool body, and the rotational joint moves the head unit in a radial direction relative to the central longitudinal axis such that, in a first position of the rotational joint, the second longitudinal axis of the head unit is radially offset from the central longitudinal axis.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic side view of an example laser tool positioned adjacent to a target.

FIG. 2 is a schematic side view of a second example laser tool positioned adjacent to a target and within a piping section.

FIG. 3 is a schematic front view of a third example laser tool.

FIG. 4 is a top view of an example pipe section with material buildup, and FIG. 5 is a top view of the example pipe section after some of the material buildup is removed by a laser tool.

FIG. 6 is a flowchart describing an example method for operating an example laser tool.

Like reference numbers and designations in the various drawings indicate like elements.

### DETAILED DESCRIPTION

This disclosure describes laser tools, such as surface tools or downhole tools, which include a high power laser for ablation of a target material. The laser tool includes a head unit supporting a laser head to direct laser energy toward the target material, such as unwanted material deposits on pipeline walls. The head unit also includes a purging nozzle at an end of the head unit to purge debris or other material out of a pathway of the laser energy. The head unit is supported on a housing of the laser tool with a rotational joint, and the rotational joint can move the laser head, purging nozzle, or both the laser head and purging nozzle. In some instances, the rotational joint can rotate the head unit about a central longitudinal axis of the laser tool. For example, the rotational joint can move the laser head in a circular motion and along a circular path around the central longitudinal axis. In certain implementations, the rotational joint can move the head unit radially away from or closer to the central longitudinal axis, in addition to or separate from the rotational movement. In some examples, the purging nozzle has a linear or rectangular shape that is angled radially inward, such that as the head unit follows a circular path around the central longitudinal axis, the purged debris is directed away from and out of the laser pathway. In some instances, the laser tool includes a vacuum that collects all or a portion of the ablated material from the target material.

The laser tool can be used in well surface applications, in downhole wellbore applications, or in other technologies and industries to ablate unwanted material. In some instances, such as in downhole or surface pipelines, unwanted material deposits and buildups can accumulate on interior surfaces of the pipelines. Laser tools of the present disclosure can be disposed in a pipeline to ablate and remove the unwanted material. In conventional laser tools, a stationary laser head emits a controlled laser beam, and purging nozzles attempt to move debris out of the way of the laser beam. However, inefficient or incomplete purging of the debris from the path of the laser beam can block the laser beam, where energy is wasted on purged material instead of on the target material. Further, if the laser beam is not as wide as the target, then the laser beam cannot provide a complete removal of the unwanted material because the laser beam cannot position itself to all areas of the target material.

In the present disclosure, the laser tool includes a purging nozzle that is angled to push purged material out of the pathway of the laser beam, and the head unit can move radially inward or outward, and can rotate about a central longitudinal axis of the laser tool, for example, to simultaneously purge material out of the pathway of the laser energy and move the laser energy pathway along a circular pathway using the rotational joint. The laser energy pathway in a laser tool of the present disclosure can adjust to variable widths of a target, and a circular pathway of the laser energy pathway can provide a more complete ablation of a target material. The rotational joint can maintain a downward axial direction of the laser energy pathway while allowing for radial movement and circular rotation about the central longitudinal axis, which, for example, can promote a more complete ablation of a target material and less risk to damage of an outer pipeline material. In some instances, using laser energy to ablate unwanted material in pipelines can minimize logistics of acidizing piping materials, reduce the risk of damaging piping material, or both. These benefits can eliminate the need to replace piping, and instead, piping can be cleaned or cleared. In some examples, a laser tool can be used to ablate unwanted materials in piping in situ. For example, a laser tool can be disposed in an operating pipeline adjacent to a blockage or other presence of unwanted material, and the laser tool can completely or partially ablate the blockage or unwanted material in the pipeline.

FIG. 1 is a partial schematic side view of an example laser tool 100 positioned adjacent to a target 102. The example laser tool 100 includes a tool body 104 disposed partially or completely along a central longitudinal axis A-A, and a head unit 106 connected to the tool body 104 with a rotational joint 108. The tool body 104 can include a substantially cylindrical body aligned with the central longitudinal axis A-A, or can take on other shapes and orientations. The example laser tool 100 operates to direct laser energy from the head unit 106, such as in the form of a high power laser (HPL) beam, toward the target 102 to ablate material of the target 102. HPL energy can include a pulsed or continuous wave laser or a plurality of lasers with high energy. The term high power refers to lasers with peak power at or above 100 Watts (W). In some implementations, such as in downhole applications, HPLs can be continuous or pulsed, with power ranging from 1 kW to 1 Megawatt (MW). HPL can be in the visible and infrared range with a wavelength, for example, from 450 nanometers (nm) to 4200 nm.

The rotational joint 108 connects to the tool body 104 on a first longitudinal end of the rotational joint 108, and connects to the head unit 106 on a second, opposite longitudinal end of the rotational joint 108. The rotational joint 108 can rotate the head unit 106 about the first longitudinal end of the rotational joint 108, for example, around the central longitudinal axis A-A. In the example laser tool 100 of FIG. 1, the first longitudinal end of the rotational joint 108 is centered on the central rotational axis A-A, however, the positioning of the rotational joint 108 on the tool body 104 can vary from its center. For example, the rotational joint 108 can be offset from a center of the tool body 104 and the central longitudinal axis A-A.

The rotational joint 108 of the example laser tool 100 of FIG. 1 includes a joint body 110 that is rigid. In some implementations, the joint body 110 is partially or completely hollow, for example, to allow transmission of cables, power lines, communication lines, or a combination of these transmission lines. The one or more transmission lines can be used to transmit data, power, laser energy, a combination of these, or other matter, between components of the head unit 106 and components of the example laser tool 100 on the opposite side of the rotational joint 108 than the head unit 106.

In some instances, the joint body 110 includes one, two, or more tubular portions connected together, such as with hinge joints or other connections, resulting in the joint body 110 having a first (proximal) end positioned at a first radial location relative to the central longitudinal axis A-A and having a second (distal) end positioned at a second radial location relative to the central longitudinal axis A-A, where the second radial location is more radially outward than the first radial location. In some examples, the joint body 110 of the rotational joint 108 includes a shaped pipe that connects to the tool body 104 with a rotational plate 112 (or other rotating structure), and the rotational plate 112 effects rotation onto the joint body 110. The distal end of the joint body 110 (nearest to the head unit 106) is radially offset from the proximal end of the joint body 110 (nearest to the tool body 104), and rotation of the joint body 110 centered on the proximal end moves the distal end of the joint body 110 along a circular path.

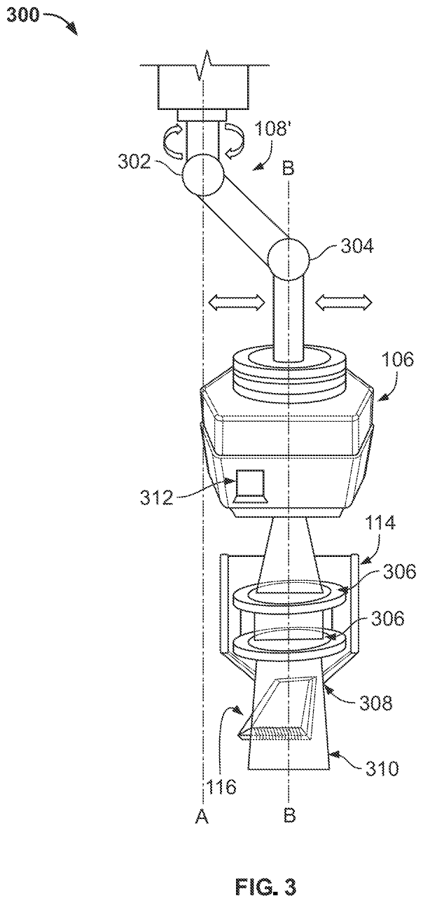

The rotational joint 108 can take on a variety of forms other than the rigid joint body 110 of the example laser tool 100 of FIG. 1. For example, the joint body 110 of the rotational joint 108 can include a controllable robotic arm, controllable hinge joint(s), controllable universal joint(s), a combination of these, or other constructions to support controlled positioning, controlled movement, or both positioning and movement of the head unit 106 attached to the distal end of the joint body 110 relative to the proximal end of the joint body 110. The rotational joint 108 is described in greater detail later with respect to FIG. 3.

The head unit 106 of the example laser tool 100 includes a laser head 114 to direct laser energy toward the target 102 and along a second longitudinal axis B-B of the head unit 106. In the example laser tool 100 of FIG. 1, the second longitudinal axis B-B is parallel to and radially offset from the central longitudinal axis A-A. The offset between the axis B-B at a center of the laser head 114 and the central longitudinal axis A-A allows for movement of the laser head 114 along a circular pathway 118 of the laser energy from the laser head 114 against the target 102 as the rotational joint 108 rotates the head unit 106 around the central longitudinal axis A-A. In some implementations, the circular pathway 118 of a HPL from the laser head 114 can provide a more complete ablation of a target 102 by moving the laser energy across an entire circular surface of the target 102, for example, instead of a stationary centered laser beam that may not reach peripheral edges of the target 102. In some examples, unwanted material buildup on a pipe accumulates on its inner surfaces at the peripheral edge of the pipe. In these examples, allowing the laser energy from the radially offset laser head 114 to focus on the location of greater material buildup at the peripheral edges can provide a more complete and more efficient ablation of the target 102.

The laser head 114 of the example laser tool 100 can include a variety of components to transmit and focus laser energy into a directed laser beam 120. In some implementations, the laser head 114 supports and includes one or more optical lenses, for example, to control or direct the laser energy through the laser head 114 and out of a laser opening of the laser head 114. The laser opening, the one or more optical lenses, or both the laser opening and the optical lens(es) of the laser head 114 can determine a shape of a resultant laser beam 120 out of the laser head 114 that is directed toward the target 102. For example, the one or more optical lenses can manipulate the shape of the laser energy into a variety of laser beam shapes and arrays. In some implementations, the laser opening of the laser head 114 has a rectangular shape or a wedge shape, such that the laser opening directs the laser energy in a rectangular shape toward the target 102. The laser opening is shaped not to absorb laser energy from the laser head 114 nor heat the housing defining the laser opening to its melting point or deformation point. The laser opening of the laser head 114 is positioned at or near a longitudinal end of the head unit 106, for example, closer to the target 102, so that the laser energy from the laser head 114 is directed toward the target 102. For example, the laser energy can take the form of a HPL beam 120 directed substantially along (or parallel to) the second longitudinal axis B-B of the head unit 106.

In some implementations, the example laser tool 100 includes a laser source that provides the laser energy to the laser head 114. The laser source can be supported on the tool body 104, within the head unit 106, within the laser head 114, or elsewhere within the example laser tool 100. In some examples, the laser source is separate from the example laser tool 100, and laser energy is transmitted from the laser source to the example laser tool 100, such as through transmission lines or cables. The example laser tool 100 may include additional, different, or fewer components than those described to effect a resultant laser beam from the laser head 114.

The head unit 106 of the example laser tool 100 also includes a purging nozzle 116 fluidly connected to a fluid source (not shown) to purge the space between the laser head 114 and the target 102 with a fluid from the fluid source and clear a path for the laser beam so the laser energy can reach the target with little to no obstructions. Ablation of the target 102 by the laser energy generates debris 122, such as slag materials, solids, gases, and vapors. The purging nozzle 116 acts to direct some or all of this debris 122 out of the pathway of the laser energy from the laser head 114, for example, to reduce or avoid laser energy from being absorbed or reflected by the debris 122 in the laser energy pathway of the laser beam 120 between the laser head 114 and the target 102. In the example laser tool 100 of FIG. 1, the purging nozzle 116 includes a nozzle outlet that is oriented at an offset angle from second longitudinal axis B-B of the head unit 106. The nozzle outlet is oriented at this offset angle to direct the fluid across the pathway of the laser energy to better clear the laser pathway from debris. For example, the purging nozzle 116 directs the fluid at the offset angle into the pathway of the laser energy from the laser head 114 to bias ablated and purged material from the target 102 out of the pathway of the laser energy from the laser head 114.

In some implementations, the offset angle of the nozzle outlet of the purging nozzle 116 is directed at least partially toward the central longitudinal axis. For example, the offset angle can be offset between 15 and 80 degrees from the second longitudinal axis B-B, and the offset angle can be toward the central longitudinal axis A-A. This offset angle and direction biases the purged material into the space away from the laser pathway. In certain implementations, the nozzle outlet of the purging nozzle 116 and the laser head 114 are oriented at the same angle relative to the second longitudinal axis B-B.

The purging nozzle 116 can take a variety of forms. In the example laser tool 100 of FIG. 1, the nozzle outlet of the purging nozzle 116 has a linear shape, or rectangular shape, that forms a purging knife. The purging knife can be formed from a line of fluid-jetting nozzle outlet(s), which introduces a blade of fluid oriented at the offset angle into the pathway of the laser energy to sweep the pathway of debris during use. The purging nozzle 116 of the example laser tool 100 is shown as a single blade-shaped nozzle with one or more outlets; however, the shape and number of purging nozzles can vary. For example, the laser tool 100 can include multiple purging nozzles oriented at the same or different angles to direct fluid across the laser energy pathway and clear the pathway of purged debris.

The purging nozzle 116 of the example laser tool 100 is positioned at the longitudinal end of the head unit 106 closest to the target 102, and is positioned laterally adjacent to the laser head 114 such that the purging nozzle 116 directs fluid across the laser energy pathway. In some implementations, the purging nozzle 116 is positioned radially outward of the laser head 114 (relative to central longitudinal axis A-A), and the purging nozzle 116 operates to direct fluid across the laser energy pathway toward the radial center of the laser tool 100 to clear the pathway, such as toward the central longitudinal axis A-A. However, the position and orientation of the purging nozzle 116 can vary. For example, the purging nozzle 116 can be positioned at a leading edge of the laser head 114 such that the purging nozzle 116 directs fluid (and thereby purged material) across the laser energy pathway in a direction opposite to the direction of circular rotation of the head unit 106 during a rotational movement of the head unit 106 by the rotational joint 108.

In some implementations, the purging nozzle 116 includes a one-way valve that allows for flow of fluid out of the purging nozzle 116 while restricting or reducing a flow of fluid from the environment surrounding the purging nozzle 116 back into the purging nozzle 116. The one-way valve can take the form of a passive check valve, an active valve, or another valve type within the purging nozzle 116.

The head unit 106 of the example laser tool 100 can include a separate housing to enclose (partially or completely) the laser head 114 and purging nozzle 116, and support the laser head 114 and purging nozzle 116 together on the rotational joint 108. For example, the head unit 106 can include supports for cables or other transmission lines to direct respective lines to the laser head 114, purging nozzle 116, or both. For example, the head unit 106 can include supports for directing a laser energy cable from the rotational joint 108 to the laser head 114, and can include supports for directing a fluid tubing from the fluid source to the purging nozzle 116.

In some implementations, the example laser tool 100 of FIG. 1 includes a vacuum system 124 to collect some or all of the purged debris 122 directed by the purging nozzle 116 out of the pathway of the laser energy, such as any ablated material from the target 102. The vacuum system 124 includes a vacuum housing 126 connected to the tool body 104, and includes a vacuum opening 128 in the vacuum housing 126 to receive and collect the purged debris 122. In the example laser tool 100 of FIG. 1, the vacuum housing 126 is mounted on the tool body 104, though the vacuum housing 126 can be supported in the example laser tool 100 in other ways.

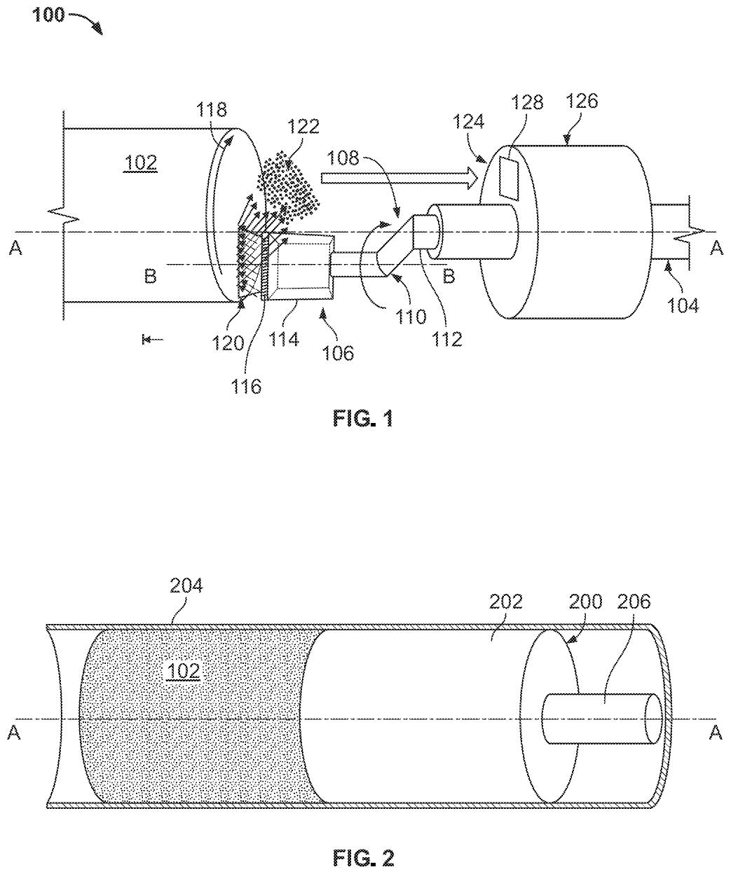

In some instances, the tool body 104 of the example laser tool 100 includes a housing that partially or completely encloses components of the example laser tool 100. For example, the housing can at least partially enclose the head unit 106 and rotational joint 108, such that only the distal longitudinal end (closest to the target 102) of the housing is open to allow the laser energy to be directed toward the target 102 without obstruction from the housing. FIG. 2 is a schematic side view of a second example laser tool 200 that is the same as the example laser tool 100 of FIG. 1, except the second example laser tool 200 includes a housing 202 that encloses the components of the example laser tool 200, for example, to protect the internal components. The second example laser tool 200 of FIG. 2 is shown as disposed adjacent to the target 102, and positioned within a piping section 204. In this example system, the target 102 can include accumulated material buildup on the inner surface of the piping section 204, and the second example laser tool 200 can be used to partially or completely remove the target 102 and remedy the obstruction present in the piping section 204.

The second example laser tool 200 is shown as carried on a string 206 within the piping section 204. While the second example laser tool 200 of FIG. 2 is shown as disposed within the piping section 204, the second example laser tool 200 can be used in a variety of other environments. For example, the piping section 204 can be part of a downhole wellbore piping where the second laser tool 200 is disposed in a downhole well environment and carried on a tubing string, or the piping section 204 can be part of a surface piping section, such as a piping in a hydrocarbon processing plant or hydrocarbon transmission pipeline, in water pipe lines, steam generator units, steam pipelines, or other applications.

In some implementations, the rotational joint 108 operates to move the head unit radially outward or radially inward relative to the central longitudinal axis A-A, in addition to or separate from any rotational movement of the head unit 106 by the rotational joint 108. For example, the rotational joint 108 supports the head unit 106 on the tool body 104, and the rotational joint 108 can to move the head unit 106 in a radial direction relative to the central longitudinal axis (for example, perpendicular to the central longitudinal axis A-A), such that in a first position of the rotational joint 108, the second longitudinal axis B-B of the head unit 106 is radially offset from the central longitudinal axis A-A. The rotational joint 108 can take a variety of forms. For example, the rotational joint 108 can include a hinge joint, a double-hinge joint, a 2 degrees-of-freedom (DOF) robotic arm, a 3-DOF robotic arm, a universal joint, a combination of these, or other types of joints to allow for the radial (or lateral) movement of the head unit 106 relative to the central longitudinal axis A-A. The rotational joint 108 can be controllable, such as with electric controls, hydraulic controls, or other types of control, to control the radial position of the rotational joint 108 and the connected head unit 106 relative to the central longitudinal axis A-A. The rotational joint 108 can communicate with and be controlled by a controller (or other control system) positioned within the example laser tool 100 or separate from the example laser tool 100, such as at a surface location in instances where the laser tool 100 is disposed downhole in a wellbore. The controller can control the positioning, movement, or both positioning and movement of the rotational joint 108, and thereby the head unit 106 attached to the distal end of the rotational joint 108, relative to the proximal end of the rotational joint 108.

FIG. 3 is a schematic front view of a third example laser tool 300 with a rotational joint 108′ in the form of a double-hinge joint. The example laser tool 300 is the same as the example laser tool 100 of FIG. 1, except the rotational joint 108′ is shown in the form of a double-hinge rotational joint, for example, to provide radial movement of the head unit 106 relative to the tool body 104. While the example laser tool 300 shows the rotational joint 108′ as the double-hinge joint, other forms of the rotational joint described earlier can be applied to the rotational joint 108′ to control positioning and movement of the rotational joint 108′.

The double-hinge rotational joint 108′ of the example laser tool 300 includes a first hinge 302 and a second hinge 304. The hinges 302 and 304 can be operated independently to control the radial location of the head unit 106 and the orientation of the second longitudinal axis B-B. For example, the first hinge 302 can primarily control the radial position of the head unit 106 relative to the central longitudinal axis A-A via rotation of the first hinge 302, and the second hinge 304 can primarily control the angular orientation of the head unit 106 and the second longitudinal axis B-B relative to the central longitudinal axis A-A. In some instances, a rotation of the first hinge 302 moves the head unit 106 from a first position to a second position radially outward of the first position. In certain instances, a rotation of the second hinge 304 aligns the second longitudinal axis B-B to be parallel to the central rotational axis A-A, or aligned at an offset angle relative to A-A. The offset angle provided by the second hinge 304 can orient the laser energy pathway to be directed partially radially inward, partially radially outward, partially radially forward, partially radially rearward, or a combination of these orientations.

The laser head 114 of the example laser tool 300 includes two optical lenses 306, for example, to control or direct the laser energy through the laser head 114 and out of a laser opening 308 of the laser head 114. The laser opening 308, the optical lenses 306, or both the laser opening 308 and the optical lenses 306 of the laser head 114 can determine a shape of the resultant laser beam 310 out of the laser head 114.

In some implementations, the head unit 106 of the example laser tool 300 (or the head unit 106 of the example laser tool 100 of FIG. 1) includes a visual sensor 312, such as a camera or other sensor, to assess an environment around the head unit 106, such as to determine a location of material buildup on a target. Feedback from the sensor 312 can be used to determine a radial movement of the rotational joint 108′, such as to direct the laser energy from the laser head 114 onto the desired location of material buildup on the target. In some instances, use of a camera or other visual sensor 312 can provide an operator or controller with visual feedback or data representative of a radial location of the head unit 106 (such as radial location of the laser beam 310) relative to the central longitudinal axis A-A, a radial location of the material buildup on a target, the longitudinal proximity of the laser head 114 relative to the material buildup, or a combination of these, and use this information to control the rotational joint 108′ (or rotational joint 108) to orient the head unit 106 in a desired orientation and position that targets the material buildup and, for example, optimizes the laser energy to focus on the desired target material. During operation of the example laser tool 300, feedback from the visual sensor 312 can be used to determine a position of the rotational joint 108′ such that the laser head 114 can target a target material, and in some examples, orient the purging nozzle 116 in a desired orientation relative to the second longitudinal axis B-B. The visual sensor(s) 312 can provide video feedback to an operator or controller, for example, in order to view scale or other target material and orient the head unit 106 with the rotational joint 108′ to focus the laser beam 310 onto the target material.

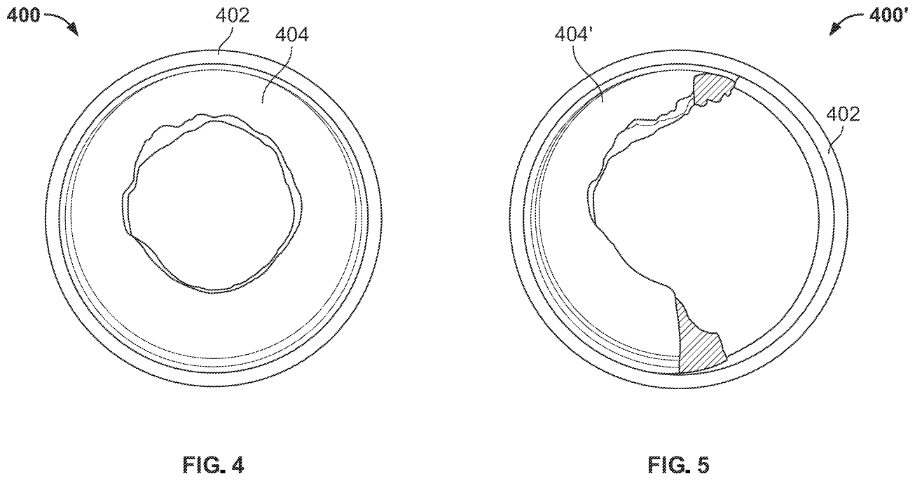

FIG. 4 is a top view of a target system 400 including an example pipe section 402 with material buildup 404 on the pipe section 402. FIG. 5 is a top view of the same target system 400′, but with some of the material buildup 404′ having been removed by an example laser tool. The example laser tool 100, 200, or 300 can be utilized to ablate or remove the material buildup 404. For example, referring to the example laser tool 100 of FIG. 1, the example laser tool 100 can operate to move the head unit 106 in a circular movement along the circular pathway 118, such as at a constant rotational speed, to ablate and remove the material buildup 404. As the head unit 106 rotates about the central longitudinal axis A-A, the material buildup 404 can break down and be removed. The example laser tool 100 can rotate the head unit 106 at a variety of speeds. In some implementations, the head unit 106 rotates at or near three revolutions per minute (RPM), though this rotational velocity can vary depending on the target material, or other factors.

In some implementations, the circular pathway 118 of the laser beam 120 from the laser head 114 provides a more complete ablation of a target by moving the laser energy across the circular pathway 118, following the location of the material buildup 404 without wasting laser energy on a center area of the pipe section 402 where no material buildup 404 is present. For example, instead of a stationary centered laser beam that may not reach peripheral edges of the material buildup 404, and instead of focusing at a center of the pipe section 402 where there is no material buildup 404 present, the example laser tool 100 can focus laser energy on the material buildup 404 by radially moving the laser head 114 such that the laser beam 120 is focused on the material buildup as it moves along the circular pathway 118. In the example target system (400, 400′) of FIGS. 4-5, the unwanted material buildup (404, 404′) accumulates on the pipe section 402 on its inner surface at the peripheral edge of the pipe section 402. In these examples, allowing the laser energy from the radially offset laser head 114 to focus on the location of greater material buildup at the peripheral edges can provide a more complete and more efficient ablation and removal of the material buildup (404, 404′).

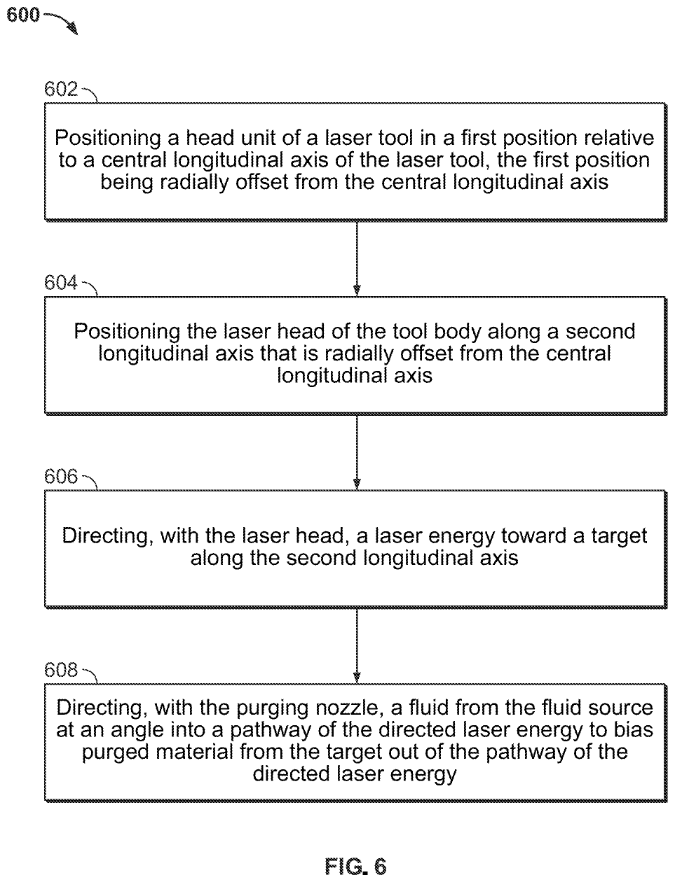

FIG. 6 is a flowchart describing an example method 600 for operating an example laser tool, for example, the example laser tool 100 of FIG. 1, the second example laser tool 200 of FIG. 2, or the third example laser tool 300 of FIG. 3. At 602, a head unit of a laser tool is positioned in a first position relative to a central longitudinal axis of the laser tool, where the first position is radially offset from the central longitudinal axis. The laser tool includes a tool body disposed at least partially along the central longitudinal axis, and the head unit connected to the tool body with a rotational joint. The head unit includes a laser head and a purging nozzle fluidly connected to a fluid source, and the purging nozzle includes a nozzle outlet oriented at an angle relative to a second longitudinal axis of the head unit. The rotational joint supports the head unit on the tool body. At 604, the laser head of the tool body is positioned along the second longitudinal axis that is radially offset from the central longitudinal axis. At 606, the laser head directs a laser energy toward a target along the second longitudinal axis. At 608, the purging nozzle directs a fluid from the fluid source at an angle into a pathway of the directed laser energy to bias purged material from the target out of the pathway of the directed laser energy.

While this disclosure contains many specific implementation details, these should not be construed as limitations on the scope of what may be claimed, but rather as descriptions of features specific to particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described above should not be understood as requiring such separation in all implementations, and it should be understood that the described components and systems can generally be integrated together in a single product or packaged into multiple products.

Thus, particular implementations of the subject matter have been described. Other implementations are within the scope of the following claims. Various modifications may be made without departing from the spirit and scope of the disclosure. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A laser tool, comprising:
a tool body disposed at least partially along a central longitudinal axis;
a head unit connected to the tool body with a rotational joint and configured to rotate around the central longitudinal axis, the head unit comprising:
a laser head configured to direct a laser energy toward a target and along a second longitudinal axis of the head unit; and
a purging nozzle fluidly connected to a fluid source and comprising a nozzle outlet oriented at an angle relative to the second longitudinal axis of the head unit, the purging nozzle configured to direct fluid at an angle into a pathway of the laser energy from the laser head to bias purged material out of the pathway of the laser energy; and
the rotational joint supporting the head unit on the tool body, the rotational joint configured to move the head unit in a radial direction relative to the central longitudinal axis such that, in a first position of the rotational joint, the second longitudinal axis of the head unit is radially offset from the central longitudinal axis.

2. The laser tool of claim 1, wherein the tool body comprises a housing at least partially enclosing the head unit and rotational joint.

3. The laser tool of claim 1, further comprising a vacuum system having a vacuum housing configured to collect the purged material.

4. The laser tool of claim 1, wherein the laser head comprises one or more optical lenses to control or direct the laser energy through the laser head.

5. The laser tool of claim 1, wherein the laser head comprises a laser opening having a rectangular shape or wedge shape, the laser opening configured to direct the laser energy in a rectangular shape toward the target.

6. The laser tool of claim 1, further comprising a laser source to provide the laser energy to the laser head.

7. The laser tool of claim 1, wherein the purging nozzle comprises a purging knife, and the nozzle outlet of the purging knife defines an outlet opening having a linear shape.

8. The laser tool of claim 7, wherein the angle of the nozzle outlet is directed at least partially toward the central longitudinal axis.

9. The laser tool of claim 1, wherein the nozzle outlet and the laser head are oriented at the same angle relative to the second longitudinal axis.

10. The laser tool of claim 1, wherein the rotational joint comprises a hinge joint configured to pivot about a hinge and move the head unit in the radial direction relative to the central longitudinal axis.

11. The laser tool of claim 1, wherein, in the first position of the rotational joint, the second longitudinal axis of the head unit is parallel to and radially offset from the central longitudinal axis of the tool body.

12. The laser tool of claim 1, wherein the head unit further comprises a camera at least partially directed at the target.

13. A method, comprising:
positioning a head unit of a laser tool in a first position relative to a central longitudinal axis of the laser tool, the first position being radially offset from the central longitudinal axis, the laser tool comprising:
a tool body disposed at least partially along the central longitudinal axis;
the head unit connected to the tool body with a rotational joint, the head unit comprising a laser head and a purging nozzle fluidly connected to a fluid source, the purging nozzle comprising a nozzle outlet oriented at an angle relative to a second longitudinal axis of the head unit, and
the rotational joint supporting the head unit on the tool body;
positioning the laser head of the tool body along the second longitudinal axis that is radially offset from the central longitudinal axis;
directing, with the laser head, a laser energy toward a target along the second longitudinal axis; and
directing, with the purging nozzle, a fluid from the fluid source at an angle into a pathway of the directed laser energy to bias purged material from the target out of the pathway of the directed laser energy.

14. The method of claim 13, further comprising rotating the head unit of the tool body about the central longitudinal axis.

15. The method of claim 13, wherein positioning the head unit in the first position comprises adjusting, with the rotational joint, a radial position of the head unit in a radial direction relative to the central longitudinal axis into the first position.

16. The method of claim 13, further comprising at least partially enclosing, with a housing, the head unit and rotational joint.

17. The method claim 13, further comprising collecting, in a vacuum housing of a vacuum system of the laser tool, the purged material from the target.

18. The method of claim 13, wherein directing the laser energy toward the target comprises directing, with one or more optical lenses in the laser head, the laser energy through the laser head.

19. The method of claim 18, wherein directing the laser energy with the one or more optical lenses comprises shaping the directed laser energy into a rectangular shape toward the target.

20. The method of claim 13, wherein directing the fluid with the purging nozzle comprises directing the fluid through a nozzle outlet of a purging knife, wherein the nozzle outlet defines an outlet opening having a linear shape.

21. The method claim 20, wherein directing the fluid at the angle through the nozzle outlet of the purging knife comprises directing the fluid out of the nozzle outlet at least partially toward the central longitudinal axis.

22. A laser tool, comprising:
a tool body disposed at least partially along a central longitudinal axis;
a head unit connected to the tool body with a rotational joint and configured to rotate around the central longitudinal axis, the head unit comprising:
a laser head configured to direct a laser energy toward a target along a second longitudinal axis of the head unit; and
a purging nozzle fluidly connected to a fluid source and comprising a nozzle outlet, the purging nozzle configured to direct fluid into a pathway of the laser energy from the laser head to bias purged material out of the pathway of the laser energy; and
the rotational joint supporting the head unit on the tool body, the rotational joint configured to move the head unit in a radial direction relative to the central longitudinal axis such that, in a first position of the rotational joint, the second longitudinal axis of the head unit is radially offset from the central longitudinal axis.
